(19) United States
(12) Patent Application Publication
(10) Pub. No.: US 2007/0058625 A1
(43) Pub. Date: Mar. 15, 2007

(54) In-vehicle terminal, server, traffic information system, link data update method, and traffic information provision method

(75) Inventors: Takumi Fushiki, Ibaraki (JP); Kazuya Kimita, Ibaraki (JP); Takayoshi Yokota, Ibaraki (JP); Masatoshi Kumagai, Ibaraki (JP)

Correspondence Address: CROWELL & MORING LLP;INTELLECTUAL PROPERTY GROUP, P.O. BOX 14300, WASHINGTON, DC, 20044-4300, US

(73) Assignee: Hitachi, Ltd., Chiyoda-ku (JP)

(21) Appl. No.: 11/518,996

(22) Filed: Sep. 12, 2006

(30) Foreign Application Priority Data
Sep. 13, 2005 (JP) 2005-265567

(51) Int. Cl. H04L 12/56

(52) U.S. Cl. 370/389

(57) ABSTRACT

The in-vehicle terminal includes an additional link database where link data including a temporary link ID (Identification) before being given by a server and established by an authorization device; a new and old link IDs database where a new and old link IDs table is saved wherein an established link ID of a link ID after being authorized by the authorization device and the temporary link ID are made to correspond to each other; a transmitting and receiving unit for transmitting traffic information data including the established link ID; and a processing unit for acquiring the established link ID included in the traffic information data, referring to the new and old link IDs table stored in the new and old link IDs database, acquiring the temporary link ID made to correspond to the established link ID, and based on the temporary link ID, acquiring link data from the additional link database.

### BACKGROUND OF THE INVENTION

1. Field of the Invention

The present invention relates to an in-vehicle terminal, a server, a traffic information system, a link data update method, and a traffic information provision method that use information transmitted from a probe car, make traffic information data, and display the traffic information.

2. Description of the Related Art

Recently is being fixed a concept of a probe car system of collecting information detected by each running vehicle becoming a probe car, for example, into an information center by radio communications. In accordance with this method, it is possible to provide in real time fine information as traffic information such as jam information, compared to a fixed sensor.

Furthermore is disclosed a road-associating apparatus, wherein a ground center transmits a link for indicating a place relating to update information and road information as a form of coordinate row data represented by position coordinates, a terminal device associates the link transmitted from the ground center based on the received coordinate row data with that of road feature data possessed by the device itself, and thereby even if a road aspect changes, the terminal device can easily handle the change (for example, Japanese Patent Laid-Open Publication No. 2003-121170 (claim 1)).

Moreover is disclosed a traffic information collection and provision system that prevents a temporary and unstable traffic concentration from occurring according to an announcement effect by increasing a frequency of an information update in a link where much information is collected from a probe car of a running car; and on the contrary, by reducing that of the information update in a link where a little information is collected from the running car (for example, Japanese Patent Laid-Open Publication No. 2002-208094 (claim 1, paragraphs 0017 to 0020, FIG. 2).

However, although link data is generally updated for every predetermined period, there is a possibility that an updated state of an in-vehicle terminal is different in every in-vehicle terminal and there is a need for transmitting traffic information corresponding to each link data version; therefore, there is a problem that a load on a communication route is larger.

Particularly, because when receiving traffic information from a probe car, there is a variation in a running state of a vehicle (because of a membership, only a specific vehicle can utilize the information and there occurs a statistical variation in its running state), there occurs a variation in receiving traffic information or newly provided link information. Therefore, there is a need for transmitting link update information over a plurality of times in update and there is a problem that a load on a communication route becomes larger.

Moreover, although information needed for a driver is that of a newly constructed road not jammed and that of a sudden jam, information not needed so much as well as that needed for him or her result in being transmitted as a same importance in the JP 2003-121170 and the JP 2002-208094. Thus, for example, in such a case that a receiving capacity of an in-vehicle terminal is smaller, there is such a problem that all truly important traffic information cannot be transmitted.

Consequently, there is a need for reducing a load on a communication route in updating traffic information.

### SUMMARY OF THE INVENTION

The present invention provides an in-vehicle terminal, a server, a traffic information system, a link data update method, and a traffic information provision method, wherein a center server receives probe car information including a running position and time information from the probe car; determines a new link, based on the probe car information; wherein when the probe car information is determined to be the new link, the center server makes link data, makes traffic information data based on the probe car information, receives link data including an established link ID (Identification) of an authorized link ID from an authorization device, makes a new-and old link IDs table based on the authorized link ID, decides a transmitting order of a plurality of pieces of the traffic information data, and transmits to the in-vehicle terminal the plurality of the pieces of the traffic information data of which the transmitting order is decided; and wherein the in-vehicle terminal acquires link data corresponding to the received traffic information data based on the new-and old link IDs table.

### BRIEF DESCRIPTION OF THE DRAWINGS

FIG. 1 is a drawing showing one example of a traffic information system related to an embodiment of the present invention.

FIG. 2 is a block diagram showing one example of a center server in the traffic information system related to the embodiment.

FIG. 3 is a block diagram showing one example of an in-vehicle terminal in the traffic information system related to the embodiment.

FIG. 4 is a timing chart showing processing flow of the traffic information system related to the embodiment.

FIG. 5 is a flowchart showing processing flow of determining, making, and saving new link data in a center server.

FIG. 6 is a drawing showing an example of a matching processing.

FIG. 7 is a drawing showing an example of a method of making new link data.

FIG. 8 is a drawing showing an example of a link data format.

FIG. 9 is a drawing showing an example of a link connection relationship data format.

FIG. 10 is a flowchart showing processing flow of making and saving traffic information data in a center server.

FIG. 11 is a drawing showing an example of a traffic information data format.

FIG. 12 is a flowchart showing processing flow of making a new and old link IDs table.

FIG. 13 is a drawing showing an example of a format of a new and old link IDs table.

FIG. 14 is a flowchart showing processing flow related to a transmitting processing in a center server.

FIG. 15 is a drawing showing an example of a format of a traffic information data array related to the embodiment.

FIG. 16 is a flowchart showing processing flow of restricting a number of transmissible data in a center server and transmitting the data to an in-vehicle terminal.

FIG. 17A is a flowchart showing processing flow of deciding a number of traffic information data to be transmitted over a different area in a center server (No. 1).

FIG. 17B is a flowchart showing processing flow of deciding the number of traffic information data to be transmitted over the different area in the center server (No. 2).

FIG. 18A is a flowchart showing processing flow in an in-vehicle terminal (No. 1).

FIG. 18B is a flowchart showing processing flow in the in-vehicle terminal (No. 2).

FIG. 19 is a link data format in a case of representing a link in a connection relationship between points.

FIG. 20 is an example of a format of traffic information data in a case of representing a link in a connection relationship between points.

FIG. 21 is a drawing showing an example of a new and old points number table in a case of representing a link in a connection relationship between points.

### BEST MODE FOR CARRYING OUT THE INVENTION

Here will be described an embodiment of the present invention, referring to drawings.

[Configuration of Traffic Information System]

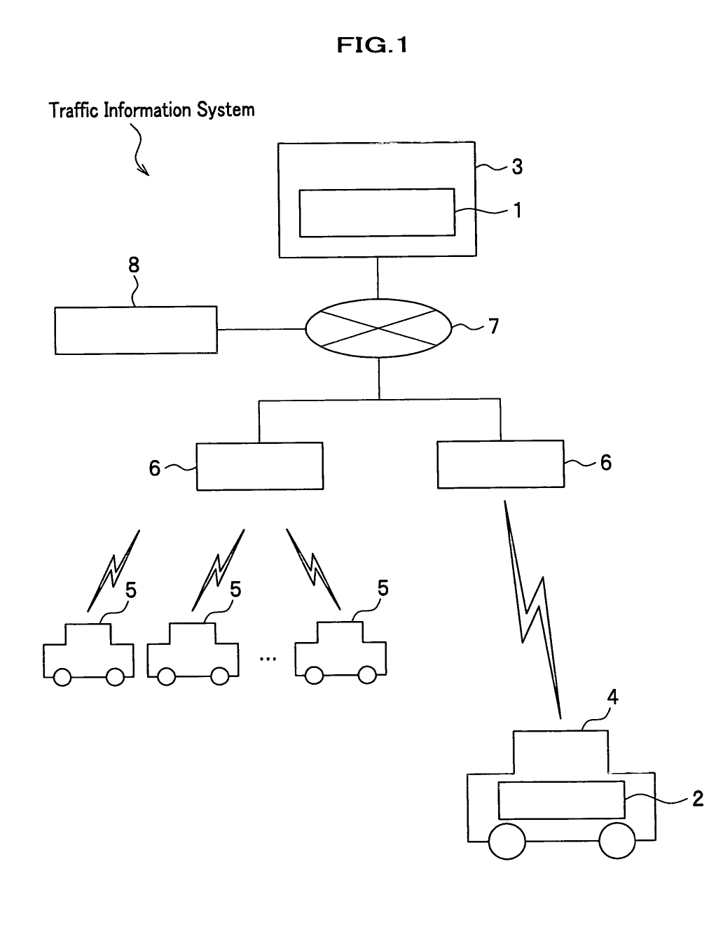

FIG. 1 is a drawing showing one example of a traffic information system related to the embodiment.

The traffic information system comprises an information center 3, an authorization device 8, and each base station 6 mutually connected via a network 7, and moreover, probe cars 5 and a vehicle 4 connected to each base station 6 via radio communications. The information center 3 comprises a center server 1 that performs such processings of making traffic information data, new link data, and a new and old link IDs (Identifications) table and transmitting; the vehicle 4 receives the traffic information data and the new and old link IDs table, and comprises an in-vehicle terminal 2 for displaying these. Moreover, the authorization device 8 performs an authorization of giving a new link ID (established link ID) to such a newly opened road, and thereby, has a function of establishing the link ID of a new link.

[Configuration of Center Server]

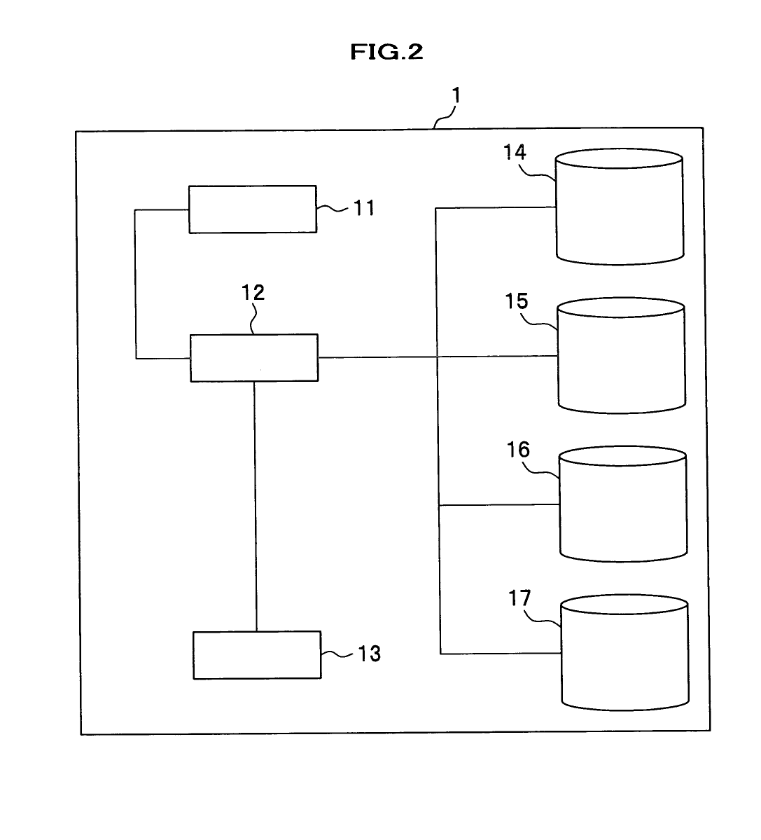

FIG. 2 is a block diagram showing one example of a center server in the traffic information system related to the embodiment.

The center server 1 comprises a processing unit 12 for performing various processings; a determination unit 13 for performing various determinations connected to the processing unit 12; a transmitting and receiving unit 11 for transmitting and receiving information; a new link traffic information database (DB) 14 where traffic information data of a new link is saved, which the new link is a link not yet authorized by the authorization device 8 (see FIG. 1); an existing link traffic information DB 15 where traffic information data of an existing link is saved, which the existing link is a link already authorized by the device 8; a new link DB 16 where link data (new link data) of the new link is saved; and an existing link DB 17 where link data (existing link data) of the existing link is saved.

[Configuration of In-Vehicle Terminal]

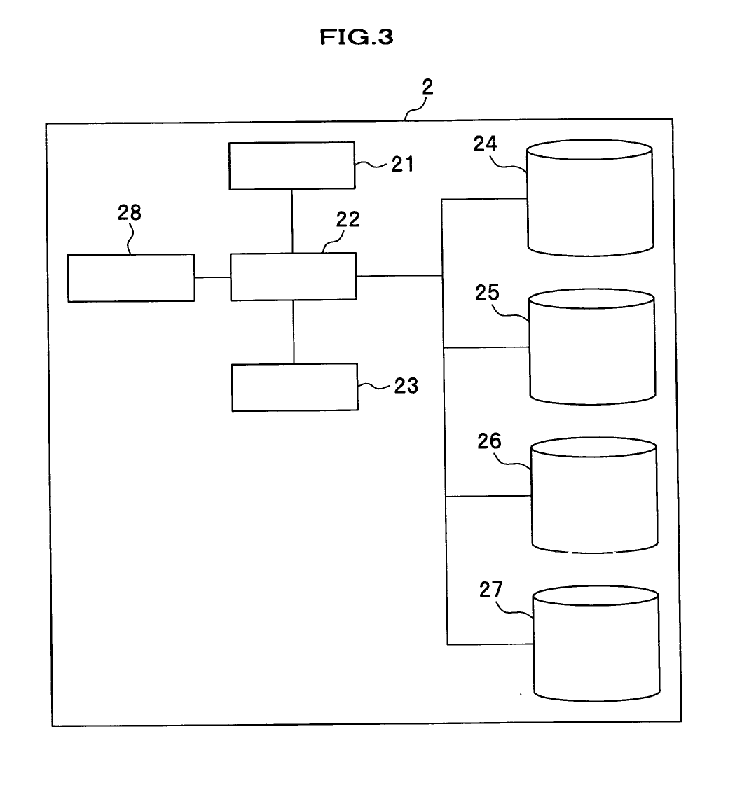

FIG. 3 is a block diagram showing one example of an in-vehicle terminal in the traffic information system related to the embodiment.

The in-vehicle terminal 2 comprises a processing unit 22 for performing various processings; a determination unit 23 for performing various determinations connected to the processing unit 22; a transmitting and receiving unit 21 for transmitting and receiving information; a display unit 28 for displaying various pieces of information; an initial link DB 24 where existing link data is saved, for example, as initial information when the in-vehicle terminal 2 is shipped from a factory; an additional link DB 25 where new link data to be transmitted is added every time when the new link data is transmitted from the information center 3 (see FIG. 1); a new and old link IDs DB 26 where the new and old link IDs table is saved; and a map DB 27 where such feature data is saved.

Here will be described a difference between the new link DB 16 and existing link DB 17 of the center server 1 and the initial link DB 24 and additional link DB 25 of the in-vehicle terminal 2.

New link data saved in the new link DB 16 of the center server 1 moves to the existing link DB 17 when it is authorized.

On the contrary, the additional link DB 25 of the in-vehicle terminal 2 does not change a temporary link ID described later to an established link ID even if the former is authorized, and does not also move link data to the initial link DB 24. Furthermore, the initial link DB 24 does not also change own save content.

[Processing of Traffic Information System]

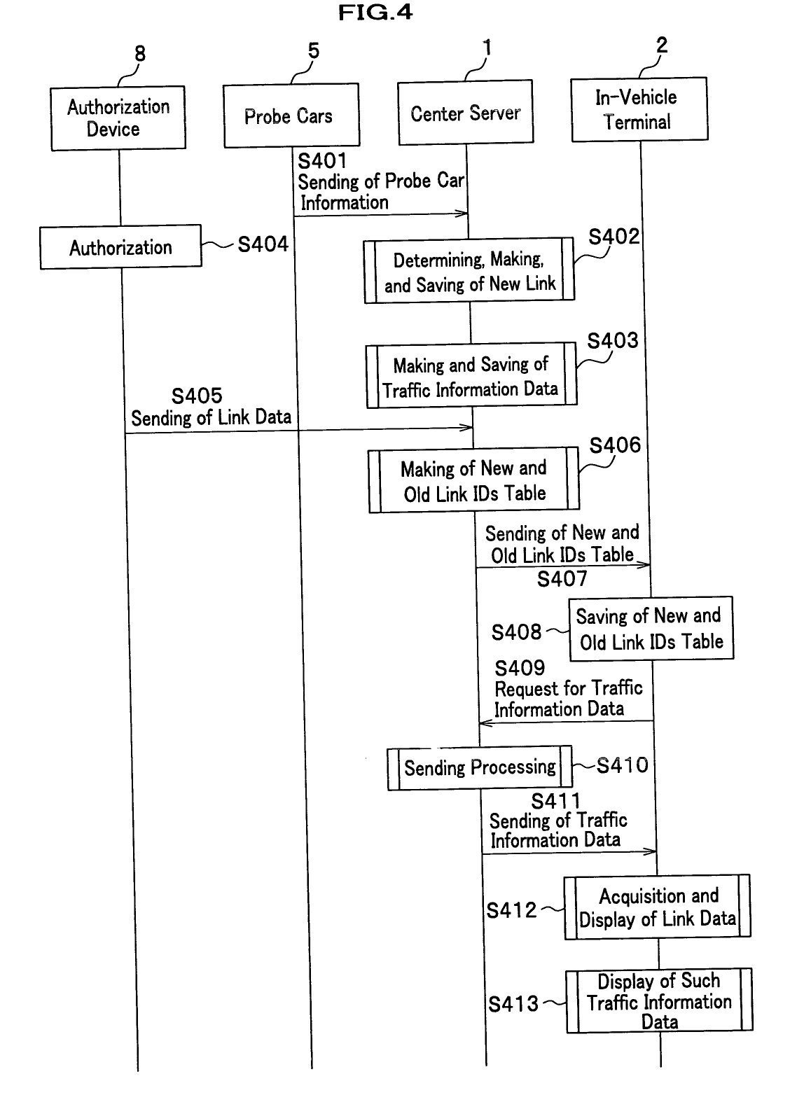

FIG. 4 is a timing chart showing processing flow of the traffic information system related to the embodiment.

Here, along FIG. 4, will be described processing flow of the traffic information system related to the embodiment, referring to FIGS. 1, 2, and 3.

Firstly, from the probe cars 5 to the information center 3 (center server 1) is transmitted probe car information (S401). Here, in the probe car information are included current running positions and time information of the probe cars 5 obtained from not shown speed sensors and gyros placed in the cars 5.

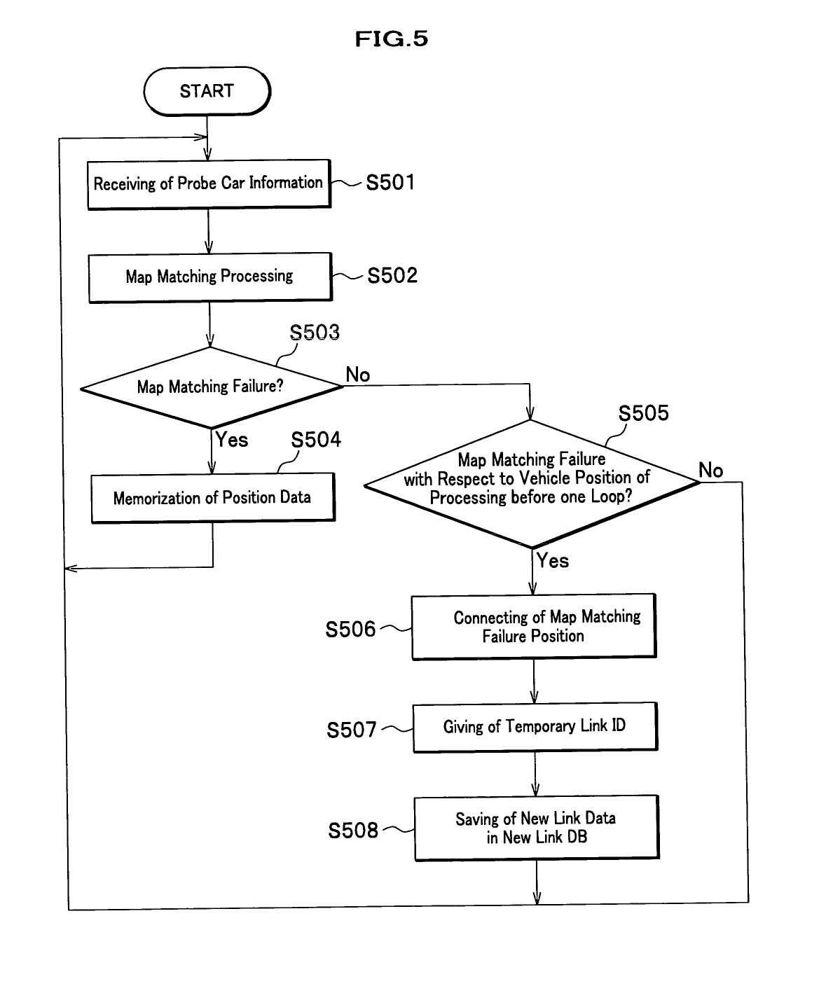

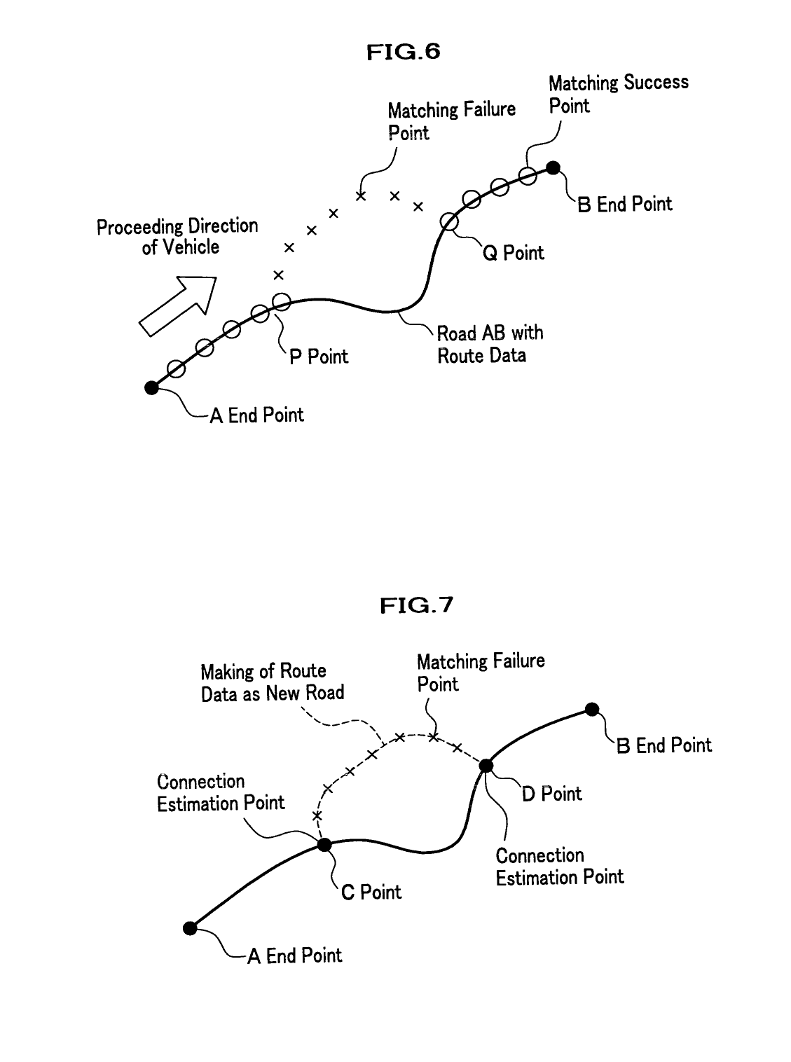

Next, the information center 3 determines a new link, based on the transmitted probe car information; when the information is determined to be the new link, the center 3 makes link data and saves it in the new link DB 16 (S402). An explanation of the processing of the step S402 will be described later, referring to FIGS. 5 and 6.

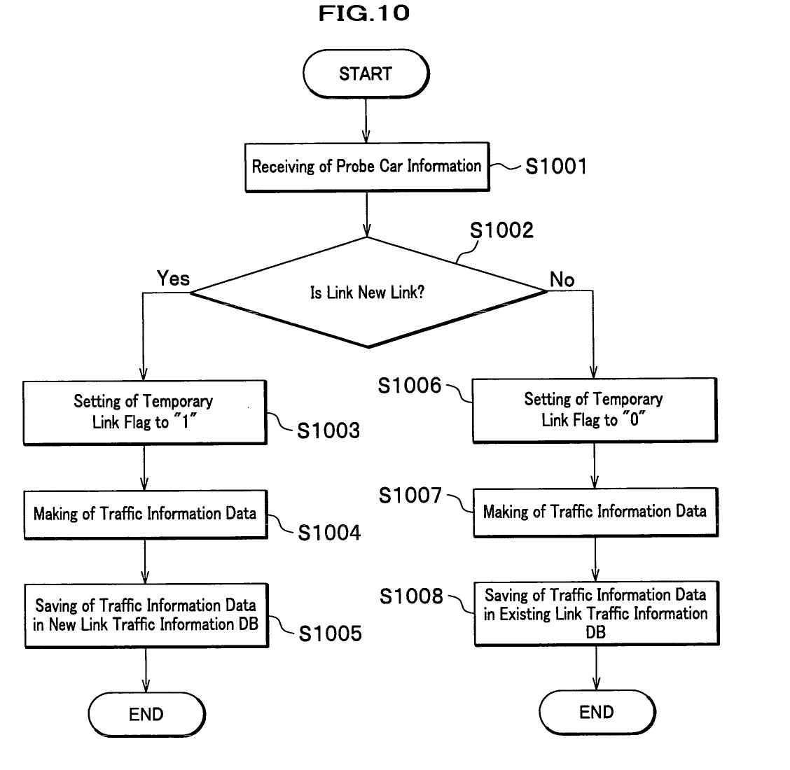

Moreover, the information center 3 makes traffic information data, based on the transmitted probe car information, and saves this in the new link traffic information DB 14 or the existing link traffic information DB 15 (S403). An explanation of the processing of the step S403 will be described later, referring to FIG. 10.

The authorization device 8 performs an authorization of giving a link ID to a new link for every predetermined period on the basis of link information, based on a map collected by a public institution or a private map company (S404). In the meantime, although in the embodiment the link ID is assumed to be automatically given by the authorization device 8, it is also available for an authorized organization, for example, such as a committee to perform the authorization and for the device 8 to acquire and memorize its result.

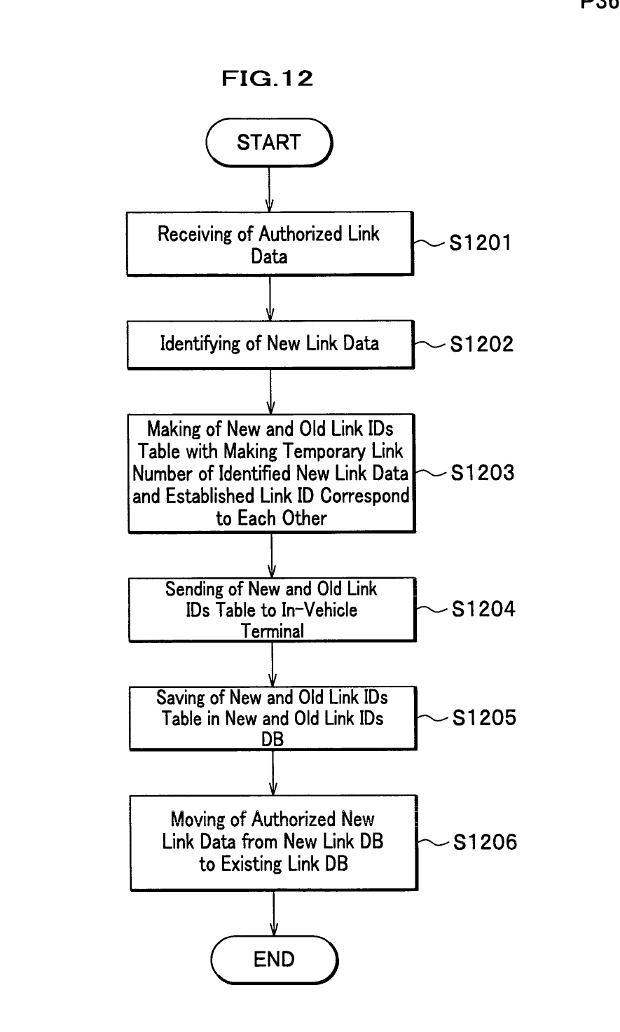

Then the link data including the authorized link ID (established link ID) is transmitted to the information center 3 (S405). Then in the information center 3 is made a new and old link IDs table, based on the established link ID transmitted from the authorization device 8 (S406). The processing of the step S406 will be described later, referring to FIG. 12.

The made new and old link IDs table is transmitted to the vehicle 4 (in-vehicle terminal 2) (S407), and saved in the new and old link IDs DB 26 via the transmitting and receiving unit 21 of the terminal 2 (S408).

Next, a traffic information request signal is transmitted from the in-vehicle terminal 2 to the information center 3, and thereby traffic information data is requested (S409).

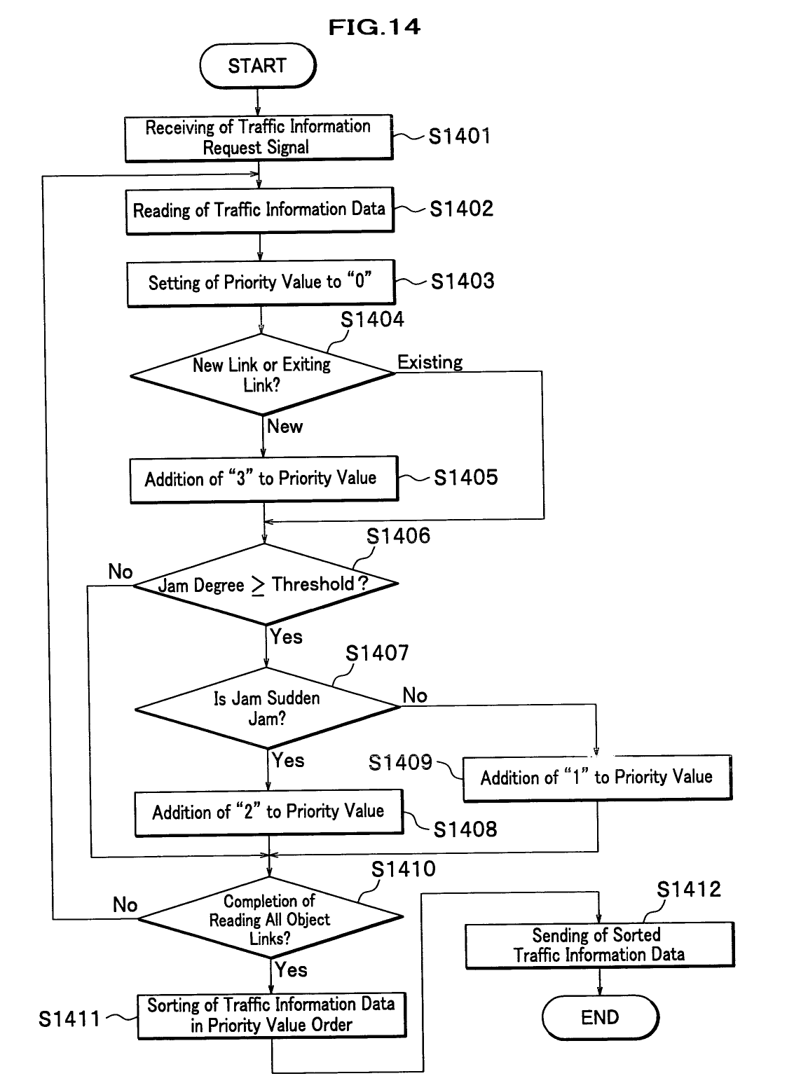

Moreover is performed a transmitting processing of such deciding a transmitting order of a plurality of pieces of traffic information data transmitted by the information center 3 that has received the traffic information request signal (S410). The processing of the step S410 will be described later, referring to FIGS. 14 to 17.

Then the information center 3 transmits the plurality of the pieces of the traffic information data, of which the transmitting order is decided, to the vehicle 4 (S411).

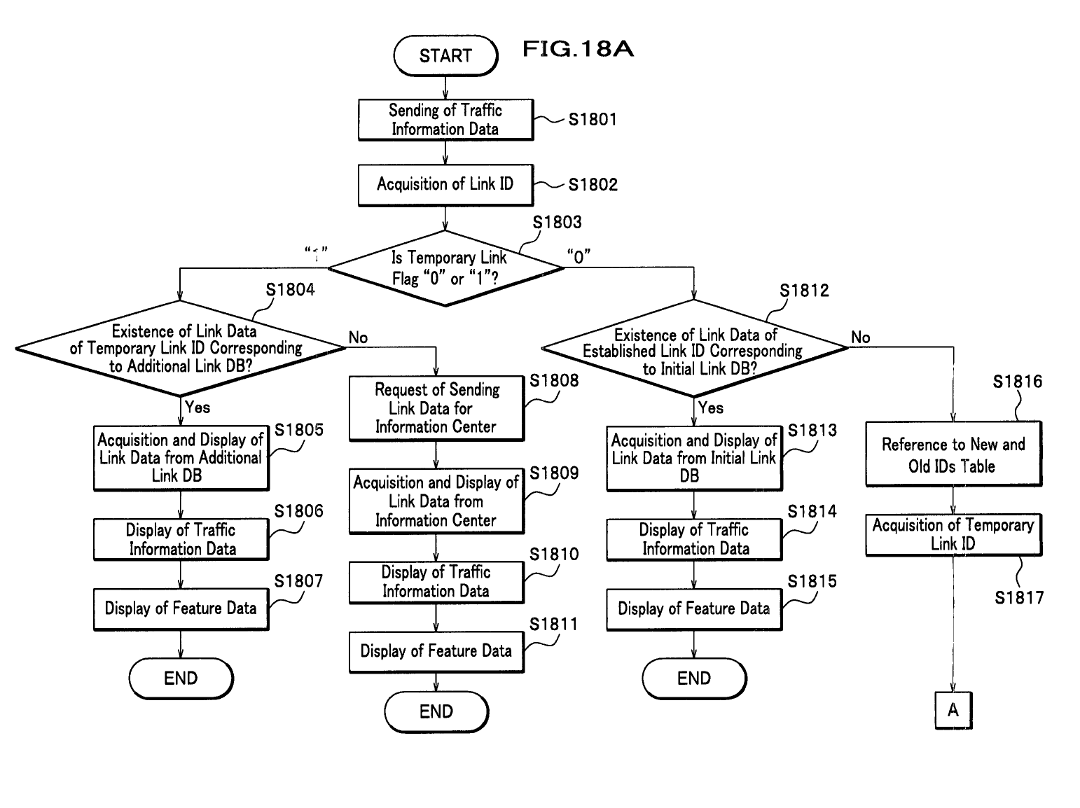

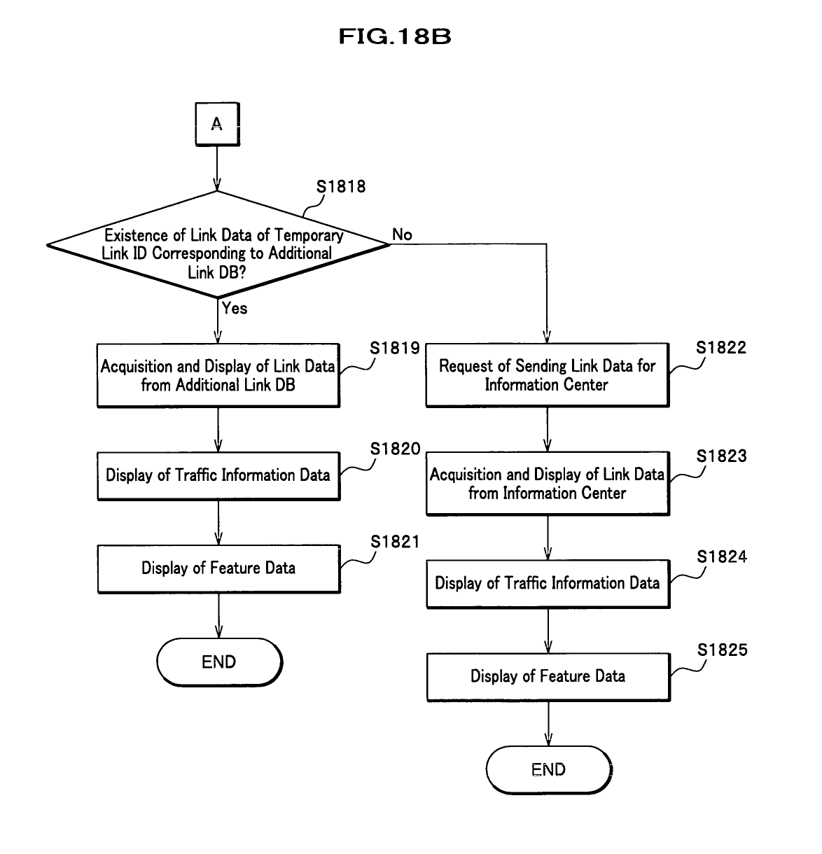

The in-vehicle terminal 2 of the vehicle 4 receiving the traffic information data acquires and displays link data corresponding to the received traffic information data (S412), based on such a new and old link IDs table, and moreover, displays such relevant traffic information data (S413). The processings of the steps S411 and S412 will be described later, referring to FIG. 18.

In the meantime, the processings from the steps 401 to 403 are performed every time when probe car information is transmitted to the information center 3 from the probe cars 5; those of the steps 404 to 407 are performed at an interval of once a year or shorter than that, for example, once a half year or every three months; and those of the steps 408 to 412 are performed every time when traffic information data is requested from the vehicle 4.

[Determining, Making, and Saving of New Link Data]

FIG. 5 is a flowchart showing processing flow of determining, making, and saving new link data in a center server.

Here, along FIG. 5, will be described the processing flow of determining, making, and saving the new link data from probe car information in the center server 1, referring to FIGS. 1 and 2.

In the meantime, the processing corresponds to that of the step S402 in FIG. 4.

After the transmitting and receiving unit 11 receives probe car information always transmitted to the unit 11 from the probe cars 5 (S501), it sends the information to the processing unit 12.

Then the processing unit 12 acquires existing link data within a predetermined distance from current positions of the probe cars 5, based on those of the cars 5 from the existing link DB 17, and performs a map matching processing with respect to the transmitted probe car information (S502).

Next, as a result of the map matching processing in the step S502, the determination unit 13 determines whether or not the map matching has failed (S503). Whether or not the map matching has failed is determined, for example, according to whether a distance between a current position of the vehicle 4 and a relevant existing link is not less than a threshold.

When the determination unit 13 determines that the map matching has failed (Yes in the S503), the processing unit 12 memorizes position data (coordinate data) of a relevant probe car 5 (S504) and returns to the processing of the step S501. When the determination unit 13 determines that the map matching has not failed (has succeeded) (No in the S503), it further determines whether or not a map matching did not fail with respect to a position of the vehicle 4 in the processing before one loop (S505).

In the step S505, with respect to the positions of the probe car 5 in the processing before one loop, when the determination unit 13 determines that the map matching did not fail (succeeded) (No in the S505), there is no need for making new link data, and the processing unit 12 returns to the processing of the step S501.

In the step S505, with respect to the position of the vehicle 4 in the processing before one loop, when the determination unit 13 determines that the map matching failed (Yes in the S505), the processing unit12 proceeds to the step S506.

In the step S506, by linking the position where the map matching has failed, the new link data is made and a temporary link ID of a link ID not authorized is given to the new link data generated by the processing unit 12 (S507). Then the processing unit 12 saves the generated link data in the new link DB 16 (S508), and returns to the processing of the step S501.

In the meantime, the processings from the steps S501 to S508 end, for example, when probe car information from the probe cars 5 is not transmitted for not less than a predetermined time.

As shown in FIG. 6, making it an example a case that, for example, one of the probe cars 5 runs a route from end points A to B, the processings of the steps S501 to S508 will be more specifically described.

FIG. 6 is a drawing showing an example of a matching processing. Referring to FIG. 2 and along FIG. 6, here will be described methods of determining and making new link data.

As shown in FIG. 6, existing link data of an existing link AB (that is, road AB), of which both ends are the end point A (point A) and the end point B (point B), is registered in the existing link DB 17, and a case is assumed that the probe car 5 runs from the point A to the point B. At this time, because the processing unit 12 succeeded in matching point data with respect to road intervals from the point A to a point P and from a point Q to the point B (points represented in 0 marks in FIG. 6), the processing unit 12 estimates that the probe car 5 ran the intervals. Because the processing unit 12 failed in matching point data with respect to a road interval from the points P to Q and cannot estimate which road the probe car 5 ran on, it is assumed that the car 5 ran on a road not registered in the existing link DB 17 and saves position data (points represented in x marks in FIG. 6) of the car 5.

FIG. 7 is a drawing showing an example of a method of making new link data.

Here will be more specifically described a processing of generating the new link data in the case of the example cited in FIG. 6 according to the step S506 in FIG. 5, using FIG. 7.

Firstly, by linking position data of matching failure positions (points represented in × marks) in FIG. 7, the processing unit 12 makes new link data (dotted line in FIG., 7) (S506). Then assuming that points where the new link data is connected to the road AB are respectively C and D, the processing unit 12 adds the new link data of this new link CD for linking the C and the D to the new link DB 16.

[Link Data Format]

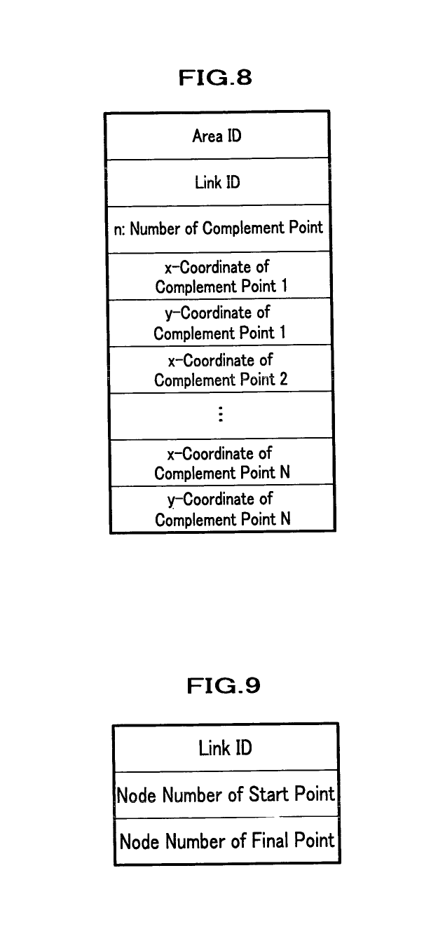

FIG. 8 is a drawing showing an example of a link data format.

Here will be described the example of the link data format along FIG. 8.

In the link data, for every link are stored an area ID, for example, such as a JIS X 0410 mesh code for identifying an area; a link ID of a number uniquely given to a link in the area ID; a number of complement points on the link; and an x-coordinate and a y-coordinate in a mesh of each complement point.

[Link Connection Relationship Data Format]

FIG. 9 is a drawing showing an example of a link connection relationship data format.

Here will be described the example of the link connection relationship data format along FIG. 9.

In the link connection relationship data format are stored such a link ID, a link start point node number, and a link final point node number. By referring to this data, a connection relationship between respective links is known.

In the meantime, in FIGS. 8 and 9 a temporary link ID or an established link ID is stored in the link ID.

[Making of Traffic Information Data]

FIG. 10 is a flowchart showing processing flow of making and saving traffic information data in a center server.

Here, along FIG. 10, will be described the processing flow of making and saving the traffic information data in the center server 1, referring to FIGS. 1 and 2.

Firstly, the transmitting and receiving unit 11 receives probe car information (S1001: corresponding to the step S401 in FIG. 4) and sends it to the determination unit 13 via the processing unit 12.

The determination unit 13 searches the new link DB 16 or the existing link DB 17, based on such position coordinates of the probe cars 5 included in the probe car information transmitted, and determines whether or not a relevant link is a new link (S1002). Whether or not the relevant link is the new link is determined according to whether the link data of the relevant link is saved in the new link DB 16 or the existing link DB 17.

When the relevant link is determined to be the new data by the determination unit 13 (Yes in S1002), the processing unit 12 proceeds to a processing of a step S1003.

In the step S1003 the processing unit 12 sets a temporary link flag to be “1”.

Next, the processing unit 12 makes traffic information data, based on the probe car information transmitted (S1004), and saves the made probe car information in the new link traffic information DB 14 (S1005).

The traffic information data is made by a travel time and a jam degree being calculated, for example, based on a running speed of the probe cars 5 included in the traffic information.

In the step S1002, when the relevant link is not a new link, that is, an existing link (No in the S1002), the processing unit 12 proceeds to a processing of a step S1006.

In the step S1006 the processing unit 12 sets the temporary link flag to be “0”.

Next, the processing unit 12 makes the traffic information data, based on the probe car information transmitted (S1007), and saves the made traffic information data in the existing link traffic information DB 15 (S1008).

In the meantime, the processings of the steps S1004 and S1007 may also be performed just after the step S1001 or just before the step S1003 or S1006.

[Traffic Information Data Format]

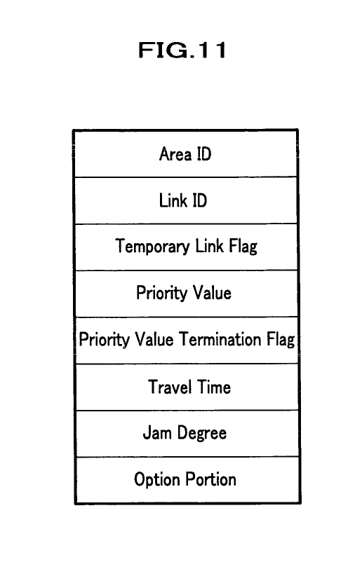

FIG. 11 is a drawing showing an example of a traffic information data format.

The traffic information data comprises an area ID, for example, such as the JIS X 0410 mesh code for identifying an area; a link ID of a number uniquely given to a link in the area ID; a temporary link flag for indicating whether or not a relevant link is a link authorized by the authorization device 8; a priority value for representing a priority of traffic information data; a priority value termination flag for indicating a termination of a priority value set in sorting the traffic information data according to a priority value order described later; a travel time; a jam degree for representing a jam extent calculated, for example, on the basis of an average speed of the vehicle 4 during linking; and an option portion where information such as a jam length and a jam top position is stored. In the meantime, in the link ID are stored a temporary link ID and an established link ID. In the meantime, the priority value termination flag is not essential.

[Making of New and Old Link IDs Table]

FIG. 12 is a flowchart showing processing flow of making a new and old link IDs table.

Here, along FIG. 12, will be described the processing flow of making the new and old link IDs table, referring to FIGS. 1, 2, and 3.

In the meantime, the processing corresponds to those of the steps S406 to S408 in FIG. 4.

Firstly, the transmitting and receiving unit 11 receives link data transmitted from the authorization device 8 (S1201), and sends it to the processing unit 12.

Then the processing unit 12 searches the new link DB 16, based on a link form of the transmitted link data, and identifies new link data estimated to be same as the transmitted link data and saved in the DB 16 (S1202).

Moreover, the processing unit 12 makes a temporary link ID of the identified new link data and an established link ID received from the authorization device 8 correspond to each other, and makes the new and old link IDs table (S1203). Thereafter, the processing unit 12 transmits the new and old link IDs table to the processing unit 22 of the in vehicle terminal 2 via the transmitting and receiving unit 11 of the center server 1, the network 7, the base station 6, and the transmitting and receiving unit 21 of the in-vehicle terminal 2 (S1204). The processing unit 22 saves the transmitted new and old link IDs table in the new and old link IDs DB 26 (S1205).

Then the processing unit 12 of the center server 1 moves the authorized new link data to the existing link DB 17 from the new link DB 16 (S1206).

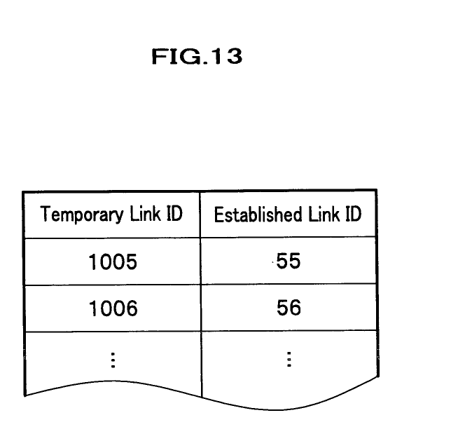

FIG. 13 is a drawing showing an example of a format of a new and old link IDs table.

As shown in FIG. 13, in the new and old link IDs table the temporary link ID and the established link ID are made to correspond to each other, and the table is stored in the new and old link IDs DB 26,.

[Setting of Transmitting Processing and Priority Value, and Sorting of Traffic Information Data]

FIG. 14 is a flowchart showing processing flow related to a transmitting processing in a center server.

Next, along FIG. 14, will be described the processing related to the transmitting processing in the center server 1, referring to FIGS. 1 and 2.

In the meantime, the processing corresponds to that of the step S410 in FIG. 4.

Firstly, a traffic information request signal is transmitted to the center server 1 of the information center 3 from the in-vehicle terminal 2 via the transmitting and receiving unit 21, the base station 6, and the network 7, and the transmitting and receiving unit 11 of the server 1 receives the traffic information request signal transmitted (S1401). In the traffic information request signal may be transmitted information input by a user via a not shown input unit comprised in the in-vehicle terminal 2, or the transmitting and receiving unit 21 (see FIG. 3) of the terminal 2 may automatically transmit the signal in such activating the terminal 2.

Furthermore, the traffic information request signal is assumed to include information in a range of traffic information data to be displayed. With respect to this, a user may also designate the range of the traffic information data to be displayed via an input unit not shown, or the processing unit 22 of the in-vehicle terminal 2 may also calculate the range of the traffic information data to be displayed according to such a current position of the vehicle 4 and a map scale.

Then the processing unit 12 reads latest updated traffic information data of an arbitrary link, which exists in the range of the traffic information data to be displayed (S1402), from the existing link DB 15 or the new link traffic information DB 14.

Next, the processing unit 12 sets a priority value of the read traffic information data to be “0” (S1403).

Then the determination unit 13 determines whether the link of the read traffic information data is an existing link or a new link (S1404). The determination of whether the link of the read traffic information data is the existing link or the new link is determined by referring to the temporary link flag of the data.

In the step S1404, when the link is determined to be the existing link (Yes in the S1404), the processing unit 12 proceeds to a processing of a step S1406.

In the step S1404, when the link is not determined to be the existing link (No in the S1404), the processing unit 12 performs a processing of adding “3” to the priority value of relevant traffic information data (S1405). According to the processing of the step S1403, because the priority value is set “0”, it becomes“3” according to that of the step S1405. According to these processings, when a link of read traffic information data is a new link, its priority value becomes “3”; when the link of the read traffic information data is an existing link, its priority value remains “0”. Accordingly, the traffic information data of the new link is transmitted to the in-vehicle terminal 2 more preferentially than that of the existing link.

Next, the determination unit 13 determines whether or not the link is jammed (S1406), depending on that a jam degree is not less than a predetermined threshold, referring to the jam degree of the traffic information data.

In the step S1406, when the jam degree is smaller than the predetermined threshold, that is, the relevant link is determined not to be jammed (No in the S1406), the processing unit 12 proceeds to a processing of a step S1410.

In the step S1406, when the jam degree is not less than the predetermined threshold, that is, the relevant link is determined to be jammed (Yes in the S1406), the processing unit 12 proceeds to a processing of a step S1407.

In the step S1407 is determined whether or not the jam of the relevant link is a sudden jam. Whether or not the jam of the relevant link is the sudden jam is determined, for example, as follows:

Firstly, the processing unit 12 acquires past traffic information data of the relevant link from the new link traffic information DB 14 or the existing link traffic information DB 15. Then the determination unit 13 compares, for example, traffic information data of a same time of several days with current traffic information data with respect to the relevant link; when determining that the relevant link is jammed in the current traffic information data although in other days the relevant link is not jammed in high probability, the unit 13 determines that the relevant link is in a state of the sudden jam.

In the step S1407, when the relevant link is determined to be in the state of the sudden jam (Yes in the S1407), the processing unit 12 performs a processing of adding “2” to the priority value of the traffic information data (S1408), and thereafter proceeds to the processing of the step S1410.

In the step S1407, when the relevant link is determined not to be in the state of the sudden jam (No in the S1407), the processing unit 12 performs a processing of adding “1” to the priority value of the traffic information data (S1409), and thereafter proceeds to the processing of the step S1410.

In the step S1410 the determination unit 13 determines whether or not all object links are read in a range of traffic information data included in the traffic information request signal and to be displayed in the display unit 28.

In the step S1410 all the object links are determined not to be read (No in the S1410), the processing unit 12 returns to the processing of the step S1402.

In the step S1410 all the object links are determined to be read (Yes in the S1410), the processing unit 12 proceeds to a processing of the step S1411.

In the step S1411 the processing unit 12 sorts all traffic information data read in priority value order.

Next, the processing unit 12 sends the sorted traffic information data to the transmitting and receiving unit 11; the unit 11 transmits the data to the in-vehicle terminal 2 via the network 7 and the base station 6 (S1412).

According to the processings of the steps 1401 to S1412, the traffic information data of a new link in a state of a sudden jam is most preferentially transmitted, and subsequently, in order of a new link in a state of a jam, a new link, an existing link in a state of a sudden jam, an existing link in a state of a jam, and an existing link.

Thus it becomes possible to preferentially transmit traffic information data higher in necessity, for example, such that a sudden jam has occurred in a newly constructed road, and thus to efficiently transmit the data.

[Format of Traffic Information Data Array]

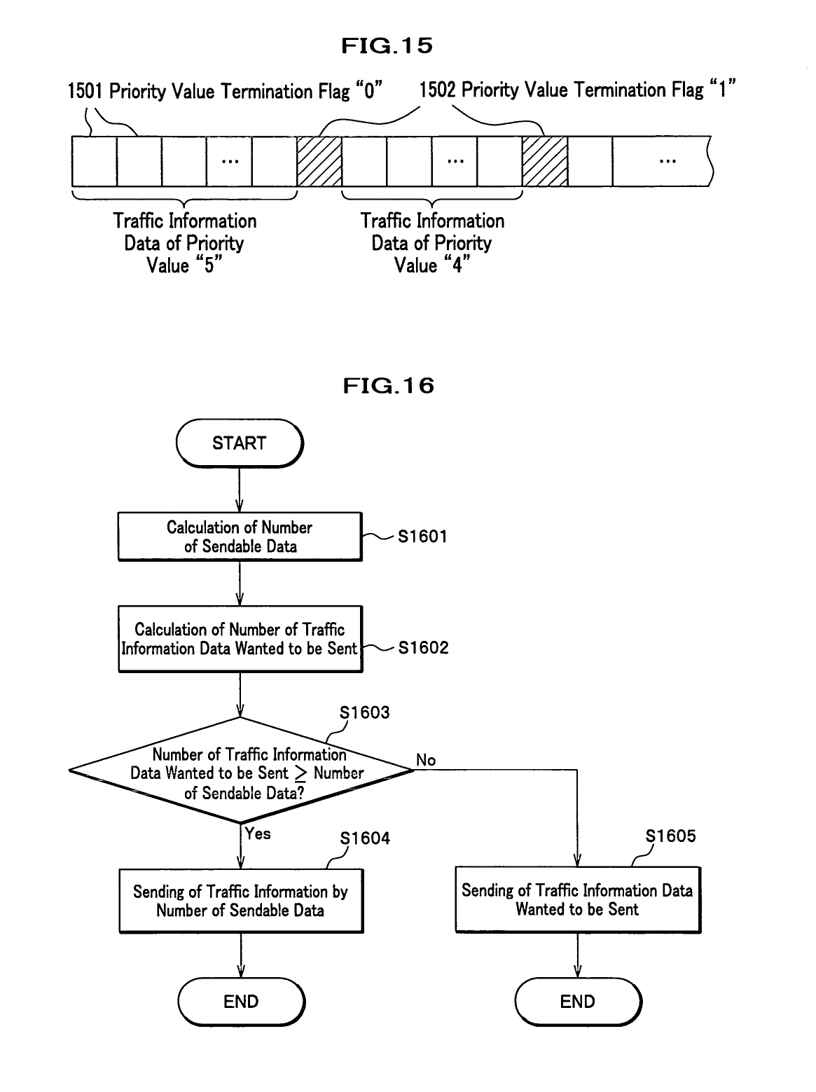

FIG. 15 is a drawing showing an example of a format of a traffic information data array related to the embodiment.

Here, along FIG. 15, will be described the example of the format of the traffic information data array related to the embodiment, referring to FIG. 11.

Rectangles 1501 and rectangles 1502 in FIG. 15 represent the format of the traffic information data in FIG. 11. Then the rectangles 1501 are traffic information data of which a priority value termination flag is “0”; the rectangles 1502 are traffic information data of which a priority value termination flag is “1”.

Then as shown in FIG. 15, traffic information data of which a priority value “5” continues, thereafter there exists traffic information data of a priority value termination flag “1” for indicating the termination of the traffic information data of the priority value “5”, and thereafter traffic information data of which a priority value “4” continues. Hereafter, traffic information data from priority values “3” to “0” is similarly arrayed.

Thus formatted, it becomes possible not only to preferentially transmit traffic information data higher in priority (a priority value is larger) to the in-vehicle terminal 2, but also to transmit traffic information data of a specific priority value, for example, depending on a receiving capacity of the terminal 2 as described later. Furthermore, by introducing a priority value flag, it becomes easier to determine a boundary between priority values. In the meantime, the priority value flag is not essential.

[Modification Example: Restriction of Number of Data to be Transmitted]

Next, along FIG. 16, will be described a method of restricting a number of transmissible data in the center server 1 and transmitting the data to the in-vehicle terminal 2, referring to FIGS. 1 and 2.

FIG. 16 is a flowchart showing processing flow of restricting a number of transmissible data in the center server 1 and transmitting the data to the in-vehicle terminal 2.

In the meantime, the processing is performed between those of the steps S1411 and S1412 in FIG. 14.

Firstly, the processing unit 12 calculates a number of transmissible data (S1601). The number of the transmissible data is calculated from such a bandwidth of a broadcast or a communication, a data amount, and a transmissible time.

Next, the processing unit 12 refers to the new link traffic information DB 14 and the existing link traffic information DB 15, and calculates a number of traffic Information data intended to be transmitted (S1602). The number of the traffic Information data intended to be transmitted is calculated, for example, from such a link number existing in a range of traffic information data intended to be displayed.

Then the determination unit 13 compares the number of the transmissible data with that of the traffic information data intended to be transmitted, and determines whether or not the number of the traffic Information data intended to be transmitted is not less than that of the transmissible data (S1603).

When the determination unit 13 determines that the number of the traffic Information data intended to be transmitted is not less than that of the transmissible data (Yes in the S1603), the transmitting and receiving unit 11 transmits traffic information data by the number of the transmissible data to the in-vehicle terminal 2 via the network 7 and the base station 6 (S1604).

When the determination unit 13 determines that the number of the traffic Information data intended to be transmitted is smaller than that of the transmissible data (No in the S1603), the transmitting and receiving unit 11 transmits all traffic information data, which is intended to be transmitted, to the in-vehicle terminal 2 via the network 7 and the base station 6 (S1605).

According to such the method, it becomes possible to preferentially transmit traffic information data higher in necessity (a priority value is larger) to the in-vehicle terminal 2 in such a case that a number of traffic Information data to be transmitted is obliged to be reduced in relation to a bandwidth of a broadcast or a communication.

[Modification Example: Decision of Number of Traffic Information Data to be Transmitted]

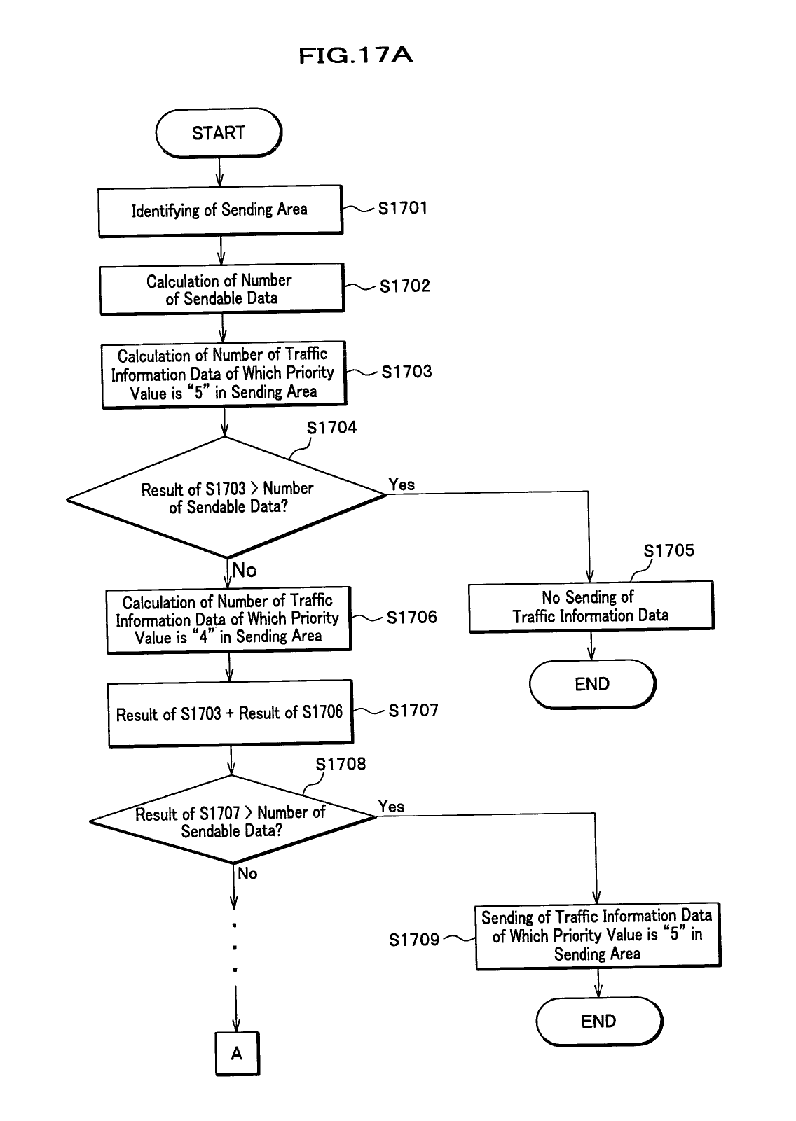

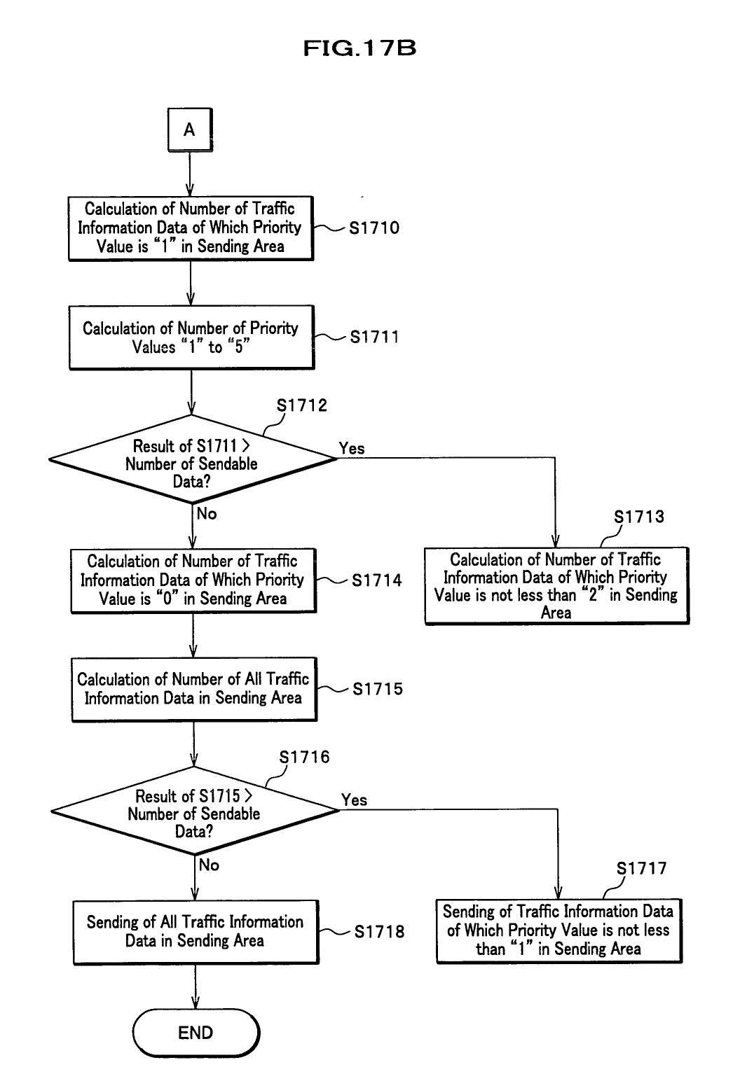

Next, along FIGS. 17A and 17B, will be described a processing of deciding a number of traffic information data to be transmitted over a different area in the center server 1, referring to FIGS. 1 and 2.

FIGS. 17A and 17B are flowcharts showing processing flow of deciding a number of traffic information data to be transmitted over a different area in the center server 1.

In the meantime, the processing is performed between those of the steps S1411 and S1412 in FIG. 14.

Firstly, the processing unit 12 identifies a transmitting area (S1701). As the transmitting area according to a request of the in-vehicle terminal 2 are designated, for example, a plurality of traffic information control areas; based on this, the processing unit 12 identifies the transmitting area.

Next, the processing unit 12 calculates a number of transmissible data (S1702). The number of transmissible data may be calculated according to the method described before, and may also be calculated, based on such a bandwidth and communication traffic amount of an area of which a communication capacity is smallest in the identified area in the step S1701.

Next, the processing unit 12 refers to the existing link traffic information DB 15 and the new link traffic information DB 14, and calculates a number of traffic information data of the priority value 5 in the transmitting area (S1703).

Then the determination unit 13 compares the result of the steps S1703 (that is, the number of the traffic information data of which the priority value is 5 in the transmitting area) with the number of the transmissible data, and determines whether or not the result of the step S1703 is larger than the number of the transmissible data (S1704).

When the result of the step S1703 is larger than the number of the transmissible data (Yes in the S1704), the number of the traffic information data of the priority value 5 is larger than that of the transmissible data; therefore, the number of the traffic information data is determined to be impossible to be transmitted and is not transmitted (S1705).

When the result of the step S1704 is not more than the number of the transmissible data (No in the S1704), the processing unit 12 proceeds to a processing of a step S1706.

In the step S1706 the processing unit 12 refers to the existing link traffic information DB 15 and the new link traffic information DB 14, and calculates a number of traffic information data of the priority value 4 in the transmitting area.

Then the determination unit 13 adds the result of the step S1703 (that is, the number of the traffic information data of which the priority value is “5” in the transmitting area) and that of the step S1706 (that is, the number of the traffic information data of which the priority value is “4” in the transmitting area) (S1707).

Next, the determination unit 13 compares the result of the step S1707 with the number of the transmissible data, and determines whether or not the result of the step S1707 is larger than the number of the transmissible data (S1708).

When the result of the step S1707 is larger than the number of the transmissible data (Yes in the S1708), the processing unit 12 transmits the traffic information data, of which the priority value is “5” in the transmitting area, by the transmitting and receiving unit 11 (S1709).

When the result of the steps S1707 is not more than the number of the transmissible data (No in the S1708), the similar processings are performed with respect to traffic information data of which the priority value is “3”.

Hereafter, the similar processings are performed with respect to traffic information data of which the priority values are “3” to “2”.

Then the processing unit 12 refers to the new link traffic information DB 14 and the existing link traffic information DB 15, and calculates a number of transmissible data of which the priority value is “1” (S1710).

Processings below will be described, referring to FIG. 17B.

Thereafter, in a step S1711 the processing unit 12 adds the result of the step S1710 (that is, the number of the traffic information data of which the priority value is “1” in the transmitting area) and the numbers of the traffic information data of which the priority values are “5” to “2” in the transmitting area, and thereby calculates a number of the traffic information data of which the priority values are “5” to “1”.

Next, the determination unit 13 compares the result of the step S1711 (the number of the traffic information data of which the priority values are “5” to “1” in the transmitting area) with the number of the transmissible data, and determines whether or not the result of the step S1711 is larger than the number of the transmissible data (S1712).

When the result of the step S1711 is larger than the number of the transmissible data (Yes in the S1712), the processing unit 12 transmits the traffic information data, of which the priority value is not less than “2” in the transmitting area, by the transmitting and receiving unit 11(S1713).

When the result of the step S1711 is not more than the number of the transmissible data (No in the S1712), the processing unit 12 proceeds to a processing of a step S1714.

Then the processing unit 12 refers to the new link traffic information DB 14 and the existing link traffic information DB 15, and calculates a number of transmissible data of which the priority value is “0” (S1714).

Moreover, the processing unit 12 adds the result of the step S1714 (that is, the number of the traffic information data of which the priority value is “0”) to that of the step S1711, and thereby calculates a number of the traffic information data of which priority values are “5” to “0” (S1715).

Next, the determination unit 13 compares the result of the step S1715 (that is, the number of all traffic information data in the transmitting area) with the number of the transmissible data, and determines whether or not the result of the step S1715 is larger than the number of the transmissible data (SI716).

When the result of the steps S1715 is larger than the number of the transmissible data (Yes in the S1716), the processing unit 12 transmits the traffic information data, of which the priority value is not less than “1” in the transmitting area, by the transmitting and receiving unit 11(S1717).

When the result of the step S1715 is not more than the number of the transmissible data (No in the S1716), the processing unit 12 transmits all the traffic information data in the transmitting area by the transmitting and receiving unit 11 (S1718).

For example, when traffic information is transmitted to a plurality of traffic information control areas, a communication capacity of each traffic information control area is different due to such a difference of a communication traffic amount. Therefore, when transmitting traffic information to a plurality of traffic information control areas, there is a need for matching a transmitting amount of the traffic information with an area of which a communication capacity is smallest. At such the case, by performing the processings shown in FIGS. 17A and 17B, it becomes possible to transmit traffic information data matching a communication capacity in order of a higher priority.

In the meantime, although in the embodiment a priority value has five stages, it is not limited thereto; it may have ten stages. Furthermore, although in the embodiment a priority value of a road newly opened or jammed is assumed to be a larger value, it is not limited thereto; for example, a priority value of traffic information data of a link existing in a location (example: a distance between the link and a current position is not more than a predetermined threshold) nearer than that where the vehicle 4 is currently running may be assumed to be a larger value.

[In-Vehicle Terminal: Traffic Information Display]

FIGS. 18A and 18B are flowcharts showing processing flow in the in-vehicle terminal 2.

Next, along FIGS. 18A and 18B, will be described processing flow in the in-vehicle terminal 2, referring to FIGS. 1, 2, and 3.

In the meantime, the processing corresponds to those of the steps S412 and S413 in FIG. 4.

Firstly, the transmitting and receiving unit 21 receives traffic information data including a link ID (an established link ID or an temporary link ID) (S1801), and sends the received traffic information data to the processing unit 22.

The processing unit 22 acquires the link ID from the traffic information data (S1802).

Then the determination unit 23 searches a temporary link flag of the received traffic information data, and determines whether the flag is “0” or “1” (S1803).

When the temporary link flag is “1” (“1” in the S1803), the link is a new link not yet authorized. Accordingly, the link ID acquired in the step S1802 is the temporary link ID. Consequently, the determination unit 23 searches and determines whether or not link data of the relevant temporary link ID exists in the additional link DB 25 (S1804).

In the step S1804, when the determination unit 23 determines that the link data of the relevant temporary link ID exists in the additional link DB 25 (Yes in the S1804), the processing unit 22 acquires the link data of the relevant temporary link ID from the DB 25, and makes the display unit 28 display the link data (S1805). Next, the processing unit 22 makes the display unit 28 display the traffic information data acquired in the step 1801 (S1806). Moreover, the processing unit 22 acquires feature data from the map DB 27, and makes the display unit 28 display it (S1807).

In the step S1804, when the determination unit 23 determines that the link data of the relevant temporary link ID does not exist in the additional link DB 25 (No in the S1804), it means that the link data is not yet transmitted to the in-vehicle terminal 2 from the information center 3. Consequently, the processing unit 22 transmits a link data transmitting request signal including the relevant temporary link ID to the information center 3 via the transmitting and receiving unit 21, the base station 6, and the network 7, and thereby requests to transmit the link data (S1808).

The transmitting and receiving unit 11 of the center server 1 of the information center 3 having received the link data request signal sends the temporary link ID of the signal to the processing unit 12; the unit 12 acquires relevant link data from the new link DB 16, based on the sent temporary link ID, and transmits the relevant link data to the in-vehicle terminal 2 via the network 7 and the base station 6.

The transmitting and receiving unit 21 of the in-vehicle terminal 2 having received the link data sends the sent link data to the processing unit 22. Then the processing unit 22 makes the display unit 28 display the received link data (S1809). Next, the processing unit 22 makes the display unit 28 display the received traffic information data received in the step S1801 (S1810). Moreover, the processing unit 22 acquires feature data from the map DB 27, and makes the display unit 28 display it (S1811).

Here, a description will return to the processing of the step S1803. In the step S1803, when the temporary link flag is “0” (“0” in the S1803), the link is a link already authorized. Accordingly, the link ID acquired in the step S1802 is the established link ID. Consequently, the determination unit 23 searches and determines whether or not link data of the relevant temporary link ID exists in the initial link DB 24 (S1812).

In the step S1812, when the determination unit 23 determines that the link data of the relevant temporary link ID exists in the initial link DB 24 (Yes in the S1812), the processing unit 22 acquires the link data of the relevant temporary link ID from the DB 24, and makes the display unit 28 display the link data (S1813). Next, the processing unit 22 makes the display unit 28 display the traffic information data acquired in the step 1801 (S1814). Moreover, the processing unit 22 acquires feature data from the map DB 27, and makes the display unit 28 display it (S1815).

In the step S1812, when the determination unit 23 determines that the link data of the relevant temporary link ID does not exist in the initial link DB 24 (No in the S1812), the processing unit 22 refers to a new and old link IDs table stored in the new and old link IDs DB 26 (S1816). In the meantime, if there exists no new and old link IDs table, the in-vehicle terminal 2 acquires it from the information center 3 via the network 7 and the base station 6. Then the processing unit 22 refers to the new and old link IDs table and makes a temporary link ID and an established link ID correspond to each other, and thereby acquires the temporary link ID corresponding to the established link ID acquired in the step S1802 (S1817).

Processings below will be described, referring to FIG. 18B.

Next, the determination unit 23 searches and determines whether or not the link data of the relevant temporary link ID exists in the additional link DB 25 (S1818).

In the step S1818, when the determination unit 23 determines that the link data of the relevant temporary link ID exists in the additional link DB 25 (Yes in the S1818), the processing unit 22 acquires the relevant link data from the DB 25, based on the temporary link ID acquired in the step S1817 of FIG. 18A, and makes the display unit 28 display the link data (S1819). Next, the processing unit 22 makes the display unit 28 display the traffic information data acquired in the step 1801 (S1820). Moreover, the processing unit 22 acquires feature data from the map DB 27, and makes the display unit 28 display it (S1821).

In the step S1818, when the determination unit 23 determines that the link data of the relevant temporary link ID does not exist in the additional link DB 25 (No in the S1818), it means that the link data is not yet transmitted to the in-vehicle terminal 2 from the information center 3. Consequently, the processing unit 22 transmits a link data transmitting request signal including the relevant temporary link ID to the information center 3 via the transmitting and receiving unit 21, the base station 6, and the network 7, and thereby requests to transmit the link data (S1822).

The transmitting and receiving unit 11 of the center server 1 of the information center 3 having received the link data request signal transmits the temporary link ID of the signal to the processing unit 12; the unit 12 acquires relevant link data from the new link DB 16, based on the transmitted temporary link ID, and transmits the relevant link data to the in-vehicle terminal 2 via the network 7 and the base station 6.

The transmitting and receiving unit 21 of the in-vehicle terminal 2 having received the link data sends the transmitted link data to the processing unit 22. Then the processing unit 22 makes the display unit 28 display the received link data (S1823). Next, the processing unit 22 makes the display unit 28 display the received traffic information data received in the step S1801 (S1824). Moreover, the processing unit 22 acquires feature data from the map DB 27, and makes the display unit 28 display it (S1825).

In the meantime, in a first year when such the traffic information system in accordance with the embodiment starts to be used, there do not exist a new and old link IDs table and an authorized new link. Accordingly, when the temporary link flag is determined to be “0” in the step S1803, all the processing of the step S1812 is determined to be “Yes”.

Moreover, in displaying traffic information the processing unit 22 may buffer received traffic information data and make the display unit 28 display traffic information data when acquiring all traffic information data or when acquiring a predetermined number of traffic information data. Furthermore, the processing unit 22 may make the display unit 28 sequentially display acquired traffic information data without buffering the data.

[Modification Example]

Although in the embodiment an area ID and a link ID are used as measures for identifying a link, they are not limited thereto; for example, the link may also be identified according to a connection relationship between points (corresponding to nodes).

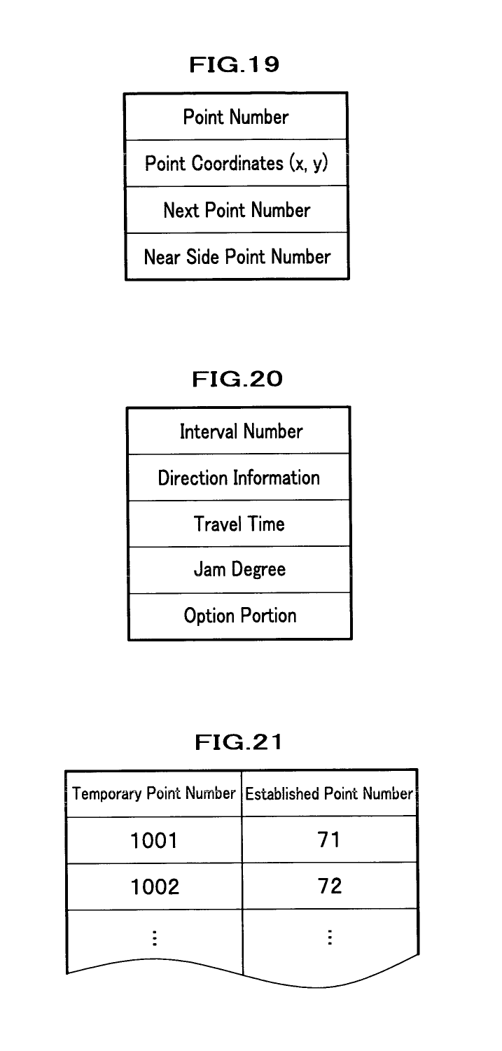

Along FIGS. 19 to 21 will be described formats of link data, traffic information data, and a new and old link IDs table in identifying a link according to a connection relationship between points.

[Modification Example of Link Data Format]

FIG. 19 is a link data format in a case of representing a link in a connection relationship between points.

As shown in FIG. 19, this modification example includes a point number uniquely given to a point, for example, such as an intersection; point coordinates (x-coordinate, y-coordinate) of the point; a next point number (larger number) of a relevant point number; and a near side point number (smaller number) of the relevant point number.

[Modification Example of Traffic Information Data Format]

FIG. 20 is an example of a format of traffic information data in a case of representing a link in a connection relationship between points.

The traffic information data in this modification example includes a interval number, direction information, a travel time, a jam degree, and an option portion.

Here, the travel time, the jam degree, and the option portion are information similar to that described with referring to FIG. 5.

The interval number corresponds to the link in the example of FIG. 5, and for example, is represented in a pair of certain point numbers (for example, 100, 101). Furthermore, the direction information respectively represents up and down according to plus and minus from a certain point number (for example: 101−1, down direction: 100+1, up direction).

[New and Old Points Number Table]

FIG. 21 is a drawing showing an example of a new and old points number table in a case of representing a link in a connection relationship between points.

As shown in FIG. 21, the temporary link ID and the established link ID in FIG. 13 are respectively a temporary link number and an established point number.

Furthermore, in a case of using the link data, the traffic information data, and the new and old points number table shown in FIGS. 19 to 21, the link ID thus described is an interval number.

As described above, it is possible to reduce a load of a communication route between the information center 3 and the in-vehicle terminal 2 by transmitting a new and old link IDs table far less in data number, compared to a method of transmitting all new link data and existing link data in update.

What is claimed is:

1. An in-vehicle terminal comprising:
an additional link database where link data is saved, including a temporary link ID (Identification) before being given by a server and established by an authorization device;
a new and old link IDs database where a new and old link IDs table is saved, wherein an established link ID of a link ID after being authorized by the authorization device and the temporary link ID are made to correspond to each other;
a transmitting and receiving unit configured to receive traffic information data including the established link ID; and
a processing unit configured to acquire the established link ID included in the traffic information data, to refer to the new and old link IDs table stored in the new and old link IDs database, to acquire the temporary link ID made to correspond to the established link ID, and based on the temporary link ID, to acquire link data from the additional link database.

2. The in-vehicle terminal according to claim 1 further comprising:
a determination unit configured to determine whether or not a link corresponding to the received traffic information data is an established link, based on determination information,
wherein the traffic information data includes the determination information configured to indicate whether or not the corresponding link is the established link, and
wherein the processing unit acquires the established link ID, based on a determination result by the determination unit.

3. A server comprising:
a new link traffic information database where traffic information data is saved, including a temporary link ID of a link ID given by the server itself and not established by an authorization device;
an existing link traffic information database where traffic information data is saved, including an established link ID of a link ID after being established by the authorization device; and
a processing unit configured to read the traffic information data, to set a priority value into the read traffic information data, based on the established link ID or the temporary link ID included in the traffic information data, and to array a plurality of pieces of the traffic information data according to the priority value.

4. The server according to claim 3 further comprising:
a determination unit configured to compare a number of transmissible data with that of traffic information data intended to be transmitted, and to determine whether or not the number of the traffic information data intended to be transmitted is larger than that of the transmissible data; and
a transmitting and receiving unit configured to transmit traffic information data by the number of the transmissible data to the in-vehicle terminal when the determination unit determines that the number of the traffic information data intended to be transmitted is larger than that of the transmissible data,
wherein the processing unit further comprises functions of calculating the number of the transmissible data from at least a bandwidth of a communication, referring to the existing link traffic information database and the new link traffic information database, and calculating the number of the traffic information data intended to be transmitted.

5. A server comprising:
a transmitting and receiving unit configured to receive probe car information including at least a running position and time information of a probe car;
a determination unit configured to determine whether or not a link corresponding to information including position coordinates of the probe car included in the probe car information is a new link; and
a processing unit configured to set determination information into traffic information data including jam information, wherein the determination information indicates whether or not the corresponding link is an established link according to a result of the determination.

6. A traffic information system comprising:
a server having functions of receiving probe car information from a probe car including at least a running position and time information of the probe car, making traffic information data based on the probe car information, receiving link data from an authorization device including an established link ID of a link ID established by the authorization device, making a new and old link IDs table where the established link ID and a temporary link ID of a link ID before being given by the server itself and established by the authorization device, transmitting the new and old link IDs table to an in-vehicle terminal, deciding a transmitting order of a plurality of pieces of the traffic information data, and transmitting the plurality of the pieces of the traffic information data of which the transmitting order is decided; and
the in-vehicle terminal having functions of saving the new and old link IDs table transmitted, and acquiring link data corresponding to the traffic information data received, based on the new and old link IDs table.

7. A link data update method in an in-vehicle terminal including a processing unit for processing information, a transmitting and receiving unit for transmitting and receiving the information, and an additional link database where link data including a temporary link ID before being given by a server and established by an authorization device is saved, and a new and old link IDs database where a new and old link IDs table where an established link ID of a link ID after being authorized by the authorization device and the temporary link ID are made to correspond to each other is saved, the method comprising the steps of:
the transmitting and receiving unit receiving traffic information data including the established link ID;
the processing unit acquiring the established link ID included in the traffic information data;
the processing unit referring to the new and old link IDs table stored in the new and old link IDs database;
the processing unit acquiring the temporary link ID made to correspond to the established link ID; and
the processing unit acquiring link data from the additional link database, based on the temporary link ID.

8. The link data update method according to claim 7, the in-vehicle terminal further including a determination unit for determining information, the method further comprising the steps of:
the determination unit determining whether or not a link corresponding to the received traffic information data is an established link, based on the determination information; and
the processing unit acquiring an established link ID, based on a determination result by the determination unit,
wherein in the traffic information is included the determination information configured to indicate whether or not the corresponding link is the established link.

9. A traffic information provision method in a server including a processing unit, a new link traffic information database saving traffic information including a temporary link ID of a link ID given by the server itself and not established by an authorization device, and an existing link traffic information database saving traffic information data including an established link ID of a link ID after being established by the authorization device, the method comprising the steps of:
the processing unit reading relevant traffic information data from the existing link traffic information database or the existing link traffic information database;
the processing unit setting a priority value into the read traffic information data, based on the established link ID included in the traffic information data and the temporary link ID included in the read traffic information data; and
the processing unit arraying a plurality of pieces of the read traffic information data according to the priority value.

10. The traffic information provision method according to claim 9, the server further including a determination unit and a transmitting and receiving unit for transmitting and receiving information, the method further comprising the steps of:
the processing unit calculating a number of transmissible data from at least a bandwidth of a communication;
the processing unit referring to the existing link traffic information database and the new link traffic information database, and calculating a number of traffic information data intended to be transmitted;
the determination unit comparing the number of the transmissible data with that of the traffic information data intended to be transmitted, and determining whether or not the number of the traffic information data intended to be transmitted is larger than that of the transmissible data; and
the transmitting and receiving unit for transmitting traffic information data by the number of the transmissible data when the determination unit determines that the number of the traffic information data intended to be transmitted is larger than that of the transmissible data to the in-vehicle terminal,

11. A traffic information provision method in a server including a processing unit for processing information, a determination unit for determining the information, and a transmitting and receiving unit for transmitting and receiving the information, the method comprising the steps of:
the transmitting and receiving unit receiving probe car information from a probe car including at least a running position and time information of the probe car,
the determination unit determining whether or not a link corresponding to information including position coordinates of the probe car included in the probe car information is a new link; and
the processing unit setting information, which indicates whether or not the corresponding link is an established link according to a result of the determination, into traffic information data including jam information.
